(19) United States
(12) Patent Application Publication
(10) Pub. No.: US 2006/0100950 A1
(43) Pub. Date: May 11, 2006

(54) Method for valuign forwards, futures and options on real estate

(75) Inventor: Andrew T. Hecht, New York, NY (US)

Correspondence Address: DAVIDSON, DAVIDSON & KAPPEL, LLC, 485 SEVENTH AVENUE, 14TH FLOOR, NEW YORK, NY, 10018, US

(73) Assignee: Global Skyline, LLC, Valley Stream, NY (US)

(21) Appl. No.: 10/963,299

(22) Filed: Oct. 12, 2004

(51) Int. Cl. G06Q 40/00

(52) U.S. Cl. 705/37

(57) ABSTRACT

A system and method for matching buy and sell orders is provided. A daily cash index of real estate values for a local region is maintained based on real estate transactions and/or real estate transactional activity, and a trading instrument representative of an interest in real estate in the local region is created. In this regard, a cash settlement of the trading instrument is a function of the daily cash index on the date of said cash settlement. In addition, a plurality of buy orders relating to the instrument are generated; a plurality of sell orders relating to the instrument are generated; and the buy and sell orders are matched to determine a purchase and sale of the instrument.

This application is related to PCT/US04/19128 filed Jun. 25, 2004, U.S. application Ser. No. 10/689,833 filed Oct. 20, 2003, and U.S. Provisional Application Ser. No. 60/403,540 filed Jun. 28, 2003, the entire disclosures of which are hereby incorporated by reference.

### BACKGROUND OF THE INVENTION

The present invention relates to the field of commodities markets and indices, and more particularly to the creation of an indices and markets for the active trading of real estate and for the valuation of forwards, futures and options on real estate.

Presently, there are active trading markets for trading instruments around the world such as stocks, bonds, forward transactions, futures options and futures contracts on commodities including agricultural products, financial instruments, stock market indices and the like. However, there exists no active trading market in real estate, other than the physical market whereby owners of property (owners or lessors) rent, lease or sell their space to renters (lessees), and buyers of property. For example, commercial lease transactions in real estate are generally for terms of between three and ten years in duration at a specific price per square area unit per year. Often an option (a “call” option) to renew a lease at a specific price, at and/or for a specific time in the future, is granted by owners or lessors to renters or lessees.

There is a direct correlation between cash leasing prices per square foot and sales prices for commercial and industrial properties, whether it is at the median level or at different building class rates. In most cases, long-term lease rates are calculated based on the actual value of the property itself. However, there is a limited amount of unbiased, current and future-related data regarding leasing rates and sales rates per square foot for commercial properties and other types of properties (including residential, industrial, vacant land and other real estate properties). Thus, any person or company that sells or rents property does so in a nontransparent market. Commercial real estate rates, whether for sales or leasing purposes, are not published or conceived in an open marketplace, despite the fact that commercial real estate sales and lease rates are an important economic indicator as well as a necessity for many companies and individuals. Similarly, there exist no benchmark prices for sales or lease rates for any type of real estate based upon an active, liquid, transparent and unbiased market.

In addition, many options in real estate exist, but they are embedded in long-term leases and thus cannot be offset or valued in any fashion. As a result, future or present renters or owners of property cannot offset their financial risk in terms of future inventory of commercial real estate or future needs for commercial real estate, as there is no direct hedge or offset for real estate. Furthermore, developers of real estate and financiers of real estate cannot guarantee current market levels of rent or lease income or current market sales prices per square foot or meter. There is also no mechanism to sell real estate short, in a specific area or sector, although there is an interest from individuals, investors, pools of capital and speculators in terms of commercial and other types of real estate values past, present and future.

### SUMMARY OF THE INVENTION

In accordance with one embodiment of the present invention, a system and method for matching buy and sell orders is provided. A daily cash index of real estate values for a local region is maintained based on real estate transactions and/or real estate transactional activity, and a trading instrument representative of an interest in real estate in the local region is created. In this regard, a cash settlement of the trading instrument is a function of the daily cash index on the date of said cash settlement. In addition, a plurality of buy orders relating to the instrument are generated; a plurality of sell orders relating to the instrument are generated; and the buy and sell orders are matched to determine a purchase and sale of the instrument.

In accordance with another embodiment of the present invention, a system and method for trading futures contracts in real estate is provided. A daily cash index of real estate values for a local region is maintained based on real estate transactions and/or real estate transactional activity, and a futures contract representative of an interest in real estate in the local region is created. In this regard, the futures contract has a settlement date, wherein a cash settlement of the futures contract is a function of the daily cash index on the settlement date. In addition, a plurality of buy orders relating to the futures contract is received; a plurality of sell orders relating to the futures contract is received; and the buy and sell orders are matched to determine a purchase and sale of the futures contract. In accordance with an alternative embodiment of the present invention, the contract is a forward contract rather than a futures contract.

In accordance with another embodiment of the present invention, a system and method for providing indices for real estate transaction values is provided. Each day, a survey is performed of actual real estate transactions executed on, and/or real estate transactional activity for, said day in a local region. In addition, each day, a daily cash index of real estate transaction values in the local region is generated based upon the survey. Preferably, each month, the daily surveys are aggregated on a monthly basis to generate a monthly cash index, and a volatility value is generated based upon the monthly cash indices over a plurality of years. In certain embodiments, the real estate transactions are commercial real estate leases. In certain embodiments, the survey includes real estate transactional activity (such as bids and offers) as well as real estate transactions, and the daily cash index is based on the real estate transactions and transactional activity. In alternative embodiments, the survey and index can be based on real estate transactional activity without reference to real estate transactions.

In certain variants of the above embodiments, based upon historical data, monthly cash indices of commercial real estate values in the local region for each month of at least 10 prior years are generated, and an initial volatility value based upon the monthly cash indices over said at least 10 prior years is generated. The volatility value is then updated based upon each monthly cash index.

In accordance with another embodiment of the present invention a method for forming an exchange is provided. A number of investors for an exchange are identified, wherein the investors are likely users of the exchange. An ownership interest in the exchange is sold to a plurality of the investors in return for an investment amount. The formation of the exchange is funded, at least in part, with the investment amount, and seats on the exchange are sold to a plurality of exchange members in return for a membership fee, wherein said seats providing the exchange members with an exclusive right to initiate trades on the exchange.

In accordance with another embodiment of the present invention, a system and method of operating an exchange is provided including a daily cash market source, a plurality of investors, a plurality of members, and an exchange. At the daily cash market source, a daily survey is performed of actual real estate transactions (preferably, leases) executed on, and/or transactional activity for, said day in a local region, and each day, a daily cash index of real estate transaction values in the local region is generated based upon the survey. At the exchange, a trading instrument representative of an interest in real estate in the local region is created, wherein a cash settlement of the trading instrument is a function of the daily cash index on the date of said cash settlement. At each of the plurality of exchange members, a plurality of buy orders and a plurality of sell orders are generated for the trading instrument. Then, at the exchange, the buy and sell orders are matched to determine a purchase and sale of the instrument, wherein each purchase has a purchase price paid by its corresponding buy order and each sale has a sale price paid to its corresponding sell order. A portion of each purchase price is paid to each of a plurality of investors in the exchange.

In accordance with another embodiment of the present invention, a system and method for trading buy and sell orders is provided. One of a buy and sell order for an instrument representative of an interest in real estate in a local region is generated, wherein a cash settlement of the trading instrument is a function of a daily cash index on the date of said cash settlement, the daily cash index being an index of real estate values for the local region. The order is transmitted to an exchange for matching buy and sell orders to determine a purchase and sale of the instrument.

In accordance with another embodiment of the present invention, a system and method for matching buy and sell orders is provided. A daily cash index of commercial real estate vacancies for a local region is maintained, and a trading instrument representative of an interest in real estate vacancies in the local region is created. A cash settlement of the trading instrument is a function of the daily cash index on the date of said cash settlement. A plurality of buy orders relating to the instrument is generated, and a plurality of sell orders relating to the instrument is generated. The buy and sell orders are matched to determine a purchase and sale of the instrument.

In accordance with another embodiment of the present invention, a system and method for matching buy and sell orders is provided. A daily cash index of hotel room rates for a local region is maintained, and a trading instrument representative of an interest in hotel room rates in the local region is created. In this regard, a cash settlement of the trading instrument is a function of the daily cash index on the date of said cash settlement. A plurality of buy orders relating to the instrument are generated and a plurality of sell orders relating to the instrument are generated. The buy and sell orders are matched to determine a purchase and sale of the instrument.

In accordance with another embodiment of the present invention, a system and method for matching buy and sell orders is provided. A daily cash index of hotel room occupancy (or vacancies) for a local region is maintained, and a trading instrument representative of an interest in hotel room vacancies in the local region is created. A cash settlement of the trading instrument is a function of the daily cash index on the date of said cash settlement. A plurality of buy orders relating to the instrument is generated, and a plurality of sell orders relating to the instrument is generated. The buy and sell orders are matched to determine a purchase and sale of the instrument.

In accordance with another embodiment of the present invention, a system and method for matching buy and sell orders is provided. A daily cash index of real estate data for a local region is maintained and a trading instrument representative of an interest in real estate data in the local region is created. In this regard, a cash settlement of the trading instrument is a function of the daily cash index on the date of said cash settlement. In addition, a plurality of buy orders relating to the instrument are generated; a plurality of sell orders relating to the instrument are generated; and the buy and sell orders are matched to determine a purchase and sale of the instrument. In this regard, the real estate data may include occupancy rates and/or commercial construction starts, and/or residential construction starts, and/or forclosure statistics, or any other real estate statistics which may include, but not be limited to sales prices, lease rates, rents, vacancy rates, capitalization rates, absorption rates, occupancy rates and any other statistically complied data relating to real estate.

In the embodiments described herein, the daily cash index is preferably based on both the real estate transactions and the real estate transactional activity. There are a number of reasons for utilizing transactional activity in combination with actual real estate values to generate the daily cash index. For example, using only actual transactions may in some cases lead to static data in that actual transactions may not occur on a frequent enough basis within a sector due to the nature of the market. Although transactions may not occur on a given day, the actual value of real estate prices or statistics may change due to other economic or political factors and variables (both affecting the real estate market itself as well as the economic environment in general). In addition, using only actual transactions may result in unrealistic “price spikes” if a transaction occurs or data is supplied outside of the statistically significant range of these statistics, all other factors being equal. This could affect the index or indices and cause a reading that is not representative of true value. Transactional activity can be used to smooth the overall data and produce a more realistic value for the statistics. This is due to the fact that transactional activity can be compiled taking into account actual transactions, bids and offers that exist in the marketplace (they may not necessarily be for public consumption on their own), micro and macro political or economic activity affecting the particular sector or market as a whole and/or other factors currently considered by those who compile real estate data.

Computer readable media, having stored thereon, computer executable process steps for performing the methods of the embodiments described above are also provided.

### BRIEF DESCRIPTION OF THE DRAWINGS

FIG. 1 is an illustrative flow chart for generating a daily cash index of real estate values in a local region.

FIG. 2 shows a preferred system for trading interests in real estate in accordance with an embodiment of the present invention.

### DETAILED DESCRIPTION OF THE PREFERRED EMBODIMENTS

In accordance with certain embodiments of the present invention, there is provided a system for creating an index and a market for the trading of real estate and for valuing futures, forward values and options on any type of real estate. The system outlined allows for a historical database as well as a marketplace in which valuation, investment, hedging and speculation can occur in a transparent and nonbiased fashion.

In one embodiment of this invention, historical databases will serve as the benchmarks for all indices that are created, and current market or trading and valuation prices will emanate from actual business that transacts on the forward or futures indices themselves. The database will serve as a historical tool from which the indices are derived. Historical prices will enable market participants to understand and incorporate historical variance or volatility into their future perceptions of price variance or volatility, which will give rise to trading and hedging decisions. A mechanism is also provided for hedging, valuation and speculation in the commercial real estate markets as well as in markets for other types of real estate (i.e., residential, industrial, land and other forms of real estate) where data exists.

The database will be derived preferably from a myriad of sources, including city, town, village or municipality records, known and licensed commercial real estate broker's records, actual lease documents, services and research companies that provide historical data in various forms of real estate data that are used and acknowledged in the marketplace, and any other sources that may be appropriate for ascertaining real estate lease rates, commercial as well as other real estate rates and data as outlined above, per square foot, meter, acre, or hectare (as appropriate).

The historical database will encompass data for a certain number of years, for example ten, fifteen, or twenty years. Local regions (hereinafter “sectors”) will be established such that, within each sector, there is a direct and high correlation in terms of the movement of real estate lease rates (commercial as well as other real estate rates and data as outlined above) over time. In this regard, depending on the correlation of real estate rates, a sector could be a city (e.g., New York City); a neighborhood, a county, even a state. A weighted average of the lease rates and/or sales rates will be calculated in order to establish a benchmark value within each sector. It is contemplated that, at least initially, data will be compiled by month and year for each sector, such that, for a twenty-year database, there will be 240 data points on a weighted average basis for each sector (12 months of data points for each of 20 years).

Forward and future values can be established by utilizing past prices, current prices and taking into account current interest rates for the period of the forward or future, as well as current inflation rates, or other micro or macro economic data which affect the specific real estate market. Option values will be calculated by utilizing the historical measure of variance or volatility as well as the volatility that is implied by buyers and sellers, with an eye to these statistical measures for the historical period as well as the market participants' future expectations that match the time until expiration of the option in question. It is preferable that standard option pricing models that are used in the equity and debt and/or commodities markets will be utilized.

In one preferred method (of many methods) of valuing forwards, futures and options on real estate, a database is first prepared. This database would ideally include data on lease or sales rates (commercial as well as other real estate rates and data as outlined above), per square unit of area (e.g., foot, meter, acre, or hectare), ascertained from city or town records for a specified number of prior years. The initial database would include lease rates (for commercial or other types of real estate) in a particular sector or region, for example, New York City, N.Y., or a neighborhood thereof. The database would be compiled preferably from city or municipality records where leases with tenures of more than three years are recorded at the Bureau of Records. The database would also be compiled from data supplied preferably by known, licensed and reputable real estate brokers, research firms specializing in real estate and other sources that could provide actual bona fide data for the appropriate sectors.

The city or municipality is broken down into sectors wherein homogeneity of lease rates per square unit area exists. An actual cash value, per year, in each sector is ascertained, and a weighted average of the lease data is compiled. Each yearly/monthly average, in each sector, is the average cash value of commercial or any other type of real estate in that particular sector for that particular year/month. In one embodiment, prices that deviate from the mean, median or mode in a statistically significant fashion can be eliminated in order to create a smooth average that is representative of the underlying market that is being represented. In the marketplace, these deviations can be used for adjusting the current pricing methods for higher/lower quality lease rates. The data are then used to measure year-to-year or month-to-month variance or volatility of the data in order to create a database of historical variance or volatility.

Database information for each sector is maintained separately, as different areas within a city or municipality will have different real estate leasing, sales or other rates (for commercial or other types of real estate as outlined above). Individual lease or sales rates, within a sector, at any specific point in time, should not deviate from the current average by more than a statistically significant amount without the occurrence of any exogenous factors. These factors may affect square foot leasing rates by virtue of their effect on the economy or economic condition of the economy as a whole, or their effect on a specific property, as the case may be.

A series of indices, per sector, allows the general population as well as those interested parties to hedge, speculate and value current positions through a transparent and published benchmark price for that specific sector. Over-the-counter transactions and/or exchange contracts are set up in order to facilitate trading, hedging, arbitrage and speculation in real estate rates in each sector (for commercial as well as other types of real estate as outlined above). Published data allow for the valuation of options embedded in current commercial leases via standard options pricing formulas for the valuation of put and call options.

The database is kept constant and up to date as new transactional activity (such as bids or offers) and real estate transactions (such as leases or sales) are entered into in the cash market. This creates a cash index, which in turn creates a mechanism for the settlement of forwards, futures and options as described below. The database as well as market data, which is defined as the trading volume, open interest, daily prices of forwards, futures and options, will be proprietary information and available for sale to interested parties to utilize for trading, valuation or any other purposes deemed necessary and appropriate.

This methodology is applicable to all cities, towns, villages and localities in the United States, as well as to other countries around the world in which lease and sales rates for commercial and other types of real estate statistics outlined above are filed and/or are available from reputable sources in order to create a historical database, which will be the basis for cash indices, futures, forwards and option prices. This methodology is applicable to all types of real estate for which historically there is data on sales prices and leasing prices.

Forward, future and option prices will be determined by transactions that occur between willing buyers and sellers. However, in the preferred embodiment of this invention, no physical delivery of any form of real estate will ever occur. Instead, the indices will serve as a tool for traders, hedgers, speculators, arbitragers and any interested parties to protect themselves or take a view as to the future movements of real estate lease or sales prices. The indices themselves, as well as all related transactions in the forward, futures and options markets, will take place independent of the underlying market for physical real estate. Although it is possible that these forwards, futures and options prices will give rise to a benchmark for pricing of the underlying physical real estate markets, it is preferred that there will never be delivery of an actual piece of real estate against these indices.

Instead, a mechanism will exist for cash settlement of transactions against the appropriate index itself. In a preferred embodiment, all open futures contracts, forward contracts and options contracts are to be settled on a cash basis between buyers and sellers based on the settlement of the cash or futures or forward indices, which are created via the database and are maintained by subsequent trading activity, on the date of settlement of the particular instrument. Thus, for example, holders of a real estate futures contract that came true would collect the proceeds of traders who put money into the market but predicted wrong, and it is expected, as discussed above, that the indices will serve as the benchmark for settlement.

However, the market in buying and selling forwards, futures and options will still be based on supply and demand fundamentals. (It is possible that the futures prices will deviate from the cash index prices due to economic data, such as interest rates or inflation rates, or the perceptions and expectations of those parties trading the forwards, futures and options products in the marketplace.) Therefore, interested parties will have the ability to go “long” or “short” in order to take a view or protect a position in the actual sector of their interest. These positions will be financial in nature, and the only mechanism for settlement will be a cash mark to market settlement against the specified index on the agreed upon settlement date.

The term real estate transactions includes, for example, sales/purchases, leases or other such related transactions.

The term “real estate transactional activity” as used herein, means data and/or conditions affecting the periodic or daily values of either specific real estate properties or real estate sectors, including but are not limited to; economic data, political conditions, interest rates, bids for properties, offers for properties, or any other data or conditions in the current climate that affect or may affect the prices, rates or statistics that are measured in the real estate market.

The term real estate data, includes, in addition to real estate transactions, other real estate related data such as vacancy rates, hotel room rates, hotel occupancy rates, data relating, to new residential or commercial construction, and other real estate statistics.

As used herein, the term “exchange” is defined broadly as any entity or group of entities which provides order matching, trade execution, and reporting, including without limitation open out cry exchanges (like the Chicago Board of Trade, New York Mercantile Exchange, or Chicago Mercantile Exchange) and electronic exchanges (like the NASDAQ) as well as Alternative Trading Systems (commonly referred to as ATSs) such as ECNs.

In addition, the following terms will be used throughout the application as defined below:

Arbitrage: The process in which professional traders simultaneously buy and sell the same or equivalent securities for a riskless or limited risk profit. A technique employed to take advantage of differences in price. It involves the simultaneous purchase of one futures, forward or options contract against the sale of another, in order to profit from disparity in price relationships. Variations include simultaneous purchases and sales of futures contracts with different delivery months or different exchanges.

Ask: the price at which a person is ready to sell. The ask price normally quoted is the lowest price at which anyone is willing to sell a commodity future, forward or option.

Bid: often referred to as quotation or quote. It is an offer to buy at a specific price. The bid is the highest price anyone has declared that he wants to pay for a commodity.

Buy on close: to buy at the end of the trading session within a closing range of prices.

Buy on opening: to buy at the beginning of the trading session at a price within the opening range of prices.

Cash market: the current cash price for the underlying market.

Cash settlement: The process by which the terms of an option or futures contract are fulfilled through the payment or receipt in dollars of the amount by which the option or future is in the money as opposed to delivering or receiving the underlying stock or commodity itself.

Cash settlement future: a future settled on a cash basis against a predetermined benchmark price or index.

Central tendency: a summary of raw data calculated to identify a significant trend or tendency in a distribution.

Clearing: the process by which the clearinghouse becomes the buyer to each seller and the seller to each buyer of a futures or options contract. The clearinghouse assumes responsibility for the performance of each contract and the protection of the buyer and seller from contractual default.

Clearing House: the part of a futures exchange that acts as a buyer for all sellers and a seller for all buyers.

Closing order: an order to buy or sell at a price that is within the closing range.

Closing range: the range of prices that is recorded during the close (vs. Opening range).

Contract month: the month specified in a futures contract in which delivery or settlement is made.

Contract trading volume: the number of contracts traded in a commodity or commodity delivery month during a specific period of time.

Contract unit: the standardized amount for a commodity futures contract.

Day order: an order to buy or sell which, if not executed, expires at the end of the trading day on which it was entered.

Debt Market: a market in which debt securities are traded, such as bonds.

Dispersion: (spread) the degree of difference between values in a distribution and the average.

Distribution: a list of raw data that can involve a small number of values or a large number of values.

Electronic Market—a platform whereby bids and offers are matched via an electronic market platform or medium.

Equity: the total cash value of an account, including the amount of profit or loss that would be incurred if the existing futures or options contract positions were liquidated at the current settlement price.

Equity Market: a market in which equity securities are trades, such as stocks.

Exchange traded: Futures and options traded on a regulated exchange.

Exponential moving average: a method for calculating the moving average for a large distribution or a large number of periods.

Fill or kill order: an order to execute a transaction immediately or cancel the order.

Fundamental Analysis: the examination of underlying factors of supply and demand in an attempt to determine market behavior and, therefore, allow one to profit from anticipating price trends.

Good Till cancelled order: an order to buy or sell that remains in effect until it is either executed or canceled.

Hedge: A conservative strategy used to limit investment loss by effecting a transaction, which offsets an existing position.

Hedging: the act of using a conservative strategy to limit investment loss by effecting a transaction, which offsets an existing position. The use of a futures, forward or options position to reduce price risk. It involves the purchase or sale of either a forward contract, a futures contract or options contracts as a temporary substitute for cash market transaction that will occur later.

Limit order: an order to buy or sell at a specified price or better. Also called a resting order.

Listed option: A put or call option that is traded on a national options exchange. Listed options have fixed strike prices and expiration dates.

Liquid Market: an actively traded market; a market that has a large number of buyers and sellers.

Liquidation: the offsetting of a futures or options position.

Lognormal distribution: A statistical distribution that is often applied to the movement of stock prices. It is a convenient and logical distribution because it implies that stock prices can theoretically rise forever but cannot fall below zero.

Long position: A position wherein an investor's interest in a particular series of forwards, futures and/or options is as a net holder (i.e., the number of contracts bought exceeds the number of contracts sold).

Mark-to-market: An accounting process by which the price of securities or commodities held in account are valued each day to reflect the last sale price or market quote if the last sale is outside of the market quote. The result of this process is that the equity in an account is updated daily to properly reflect current security or commodity prices.

Margin: a good faith deposit or performance bond whereby the customer deposits the required cash to indicate his willingness and ability to perform on the contract in the event that it is not offset before the delivery month.

Market if touched order (MIT): an order that become a market order when the commodity touched a specified price or better. An MIT order to sell becomes a market order when the commodity trades or is bid at or above the MIT price. An MIT order to buy becomes a market order when the commodity trades or is offered at or below the MIT price. Also called a board order.

Market on opening order: an order to buy or sell during the opening.

Market order: an order to be immediately executed at the best available price when the order reaches the ring.

Market on close order: an order to buy or sell during the close.

Mean: the average of distribution, calculated by adding all the values and dividing that total by the number of values.

Median: the middle value in a distribution, so that one-half of the values are greater and one-half of the values are less.

Mode: the value that appears most often in a distribution.

Model: A mathematical formula designed to price an option as a function of certain variables—generally stock or commodity price, strike price, volatility, time to expiration, dividends (if any) to be paid, and the current risk-free interest rate.

Moving average: a series of calculations used to spot trends that develop over time. This technique offsets the effect of a widely varying range by identifying the typical past experience and likely future experience.

Offer: a proposal to sell at a given price (vs. bid).

Offset: the liquidation of a long or short futures or options position.

On close: an order instructing the floor broker to buy or sell during the close of the trading session.

On opening: an order instructing the floor broker to buy or sell during the opening of the trading session.

Open interest: all futures or futures options positions that have not been liquidated. It represents the number of futures or options contract in one delivery month or one futures or options contract that have been entered into but not yet settled by an offsetting transaction or fulfilled by delivery or cash settlement. The number of outstanding option contracts in the exchange market or in a particular class or series.

Opening, The: that specific period of time designated by an exchange at the start of the trading session during which all transactions are considered made “at the opening”.

Opening order: an order to be executed during the opening. If the order cannot be done during the opening, it will be cancelled.

Open Outcry: brokers calling out in a loud, clear voice for any other broker to hear their bids and offers in the trading pits or rings of commodity exchanges.

Original Margin: (or initial margin) the amount of money that is required to be deposited in an account when a futures or options position is established.

Over-the-counter: An option or future traded off-exchange, as opposed to a listed stock or commodity option or future. The OTC future or option has a direct link between buyer and seller, has no secondary market, and has no standardization of strike prices and expiration dates or quantity.

Position: an interest in the market demonstrated by buying or selling futures, forwards or option contracts. One with a long position has bought the futures, forwards or options. One with a short position has sold the futures, forwards or options.

Position limit: the maximum number of contracts a speculator may control in a particular futures contract at any time.

Real Estate: a portion of the earth's surface extending downward to the center of the earth and upward infinitely into space including all things permanently attached thereto, whether by nature or by a person. Real estate plus all interests, benefits and rights inherent in ownership. This could include commercial real estate, which includes business property, including offices, shopping malls, theaters, hotels and parking facilities, as well as industrial real estate, including warehouses, factories, land in industrial districts and research facilities (sometimes referred to as manufacturing property), as well as rural land.

Scale order: an order that instructs a broker to buy or sell a contract at the market or at a limit. After he or she has made the initial trade, he is then instructed to buy or sell additional contracts at specified price differentials.

Scalper: a member of the exchange who day trades for his or her personal account many times in a single trading session in hopes of making a small profit on each day trade.

Settlement Price: the price established by the floor committee of the exchange that is used by the clearing house to determine the unrealized profit or loss on all open contracts on a daily basis. Also called the clearing price.

Short position: A position wherein a person's interest in a particular series of forwards, futures and/or options is as a net writer or seller (i.e., the number of contracts sold exceeds the number of contracts bought). It refers to one who sells and does not own the underlying commodity or security

Speculation: the process of buying and selling forwards, futures and options for the purpose of making a profit. A speculator will buy forwards, futures and/or options if he or she expects the price will rise and will sell forwards, futures and/or options if he or she expects the price will fall.

Spread: (1) the simultaneous purchase of one commodity forward or future contract against the sale of the same or a related commodity forward or future. (2) The purchase or sale of puts and calls on the same forward or futures contract with different expiration dates and/or strike prices.

Standard deviation: the number of units in dispersion, calculated by finding the square root of the variance.

Standard normal cumulative distribution function: of a random variable, usually, the probability F (x) that it will take on a value not greater than x; if the variable takes on only a finite set of values, then F(x) is the sum of the probabilities of the values not greater than x.

Stop order: an order to buy or sell at the market if the contract trades at or through a specified price (stop price); A stop order to sell becomes a market order if the contract trades at or below, or is offered below, the stop price. A stop order to buy becomes a market order if the contract trades at or above, or is bid at above, the stop price.

Stop-limit order: an order to buy or sell at a specified price or better if the contract trades at or through a specified price. A sell stop limit order becomes a limit order once the commodity trades at or below the specified price. A buy stop limit order becomes a buy limit order if the contract trades at or above the specified price.

Valuation: the attribution of worth to a commodity or security

Volume: the total number of purchases and sales (trades) made during a trading session. For every contract purchased there is one contract sold representing the volume of one contract.

Weighted average: a method for computing an average in which greater weight is assigned to one or more of the values in the distribution.

The term “volatility” or “variance” as used herein means the degree of deviation in a distribution of values, in this case, a measure of how spread out a distribution of prices is from a mean price. The formula for establishing volatility or variance from a mean price is computed as the average squared deviation of each number from its mean. The formula (in summation notation) for the variance in a population is

$${σ}^{2} = \frac{\sum {( X - μ )}^{2}}{N} ,$$

where μ is the mean and N is the number of scores. For example, for the numbers 1, 2, and 3, the mean is 2 and the variance is:

$${σ}^{2} = \frac{{( 1 - 2 )}^{2} + {( 2 - 2 )}^{2} + {( 3 - 2 )}^{2}}{3} = .667 .$$

The term “historical volatility” as used herein means the measure of volatility or variance that a market has exhibited through historical behavior.

The term “implied volatility” as used herein means a measure of the volatility of the underlying stock or commodity determined by using option prices currently existing in the market at the time rather than using historical data on the price changes of the underlying stock.

The term “variation margin” as used herein means the amount of money that must be deposited in a futures account to restore the equity back to the original margin requirement.

The term “forward transaction” or “forward contract” as used herein means a principal-to-principal contract between a buyer and seller in which all terms are negotiated and agreed upon between the two parties. There are no standardized terms, and all terms are negotiated between buyer and seller before the forward transaction is agreed upon.

The term “forward value” as used herein means the price agreed upon by a buyer and a seller in a forward contract.

The term “forward market” as used herein means a market for the trading of cash forward contracts, i.e., non-exchange contracts for any amount of a commodity or security, for any quality, delivered or cash settled at a time and place agreed upon by the buyer and seller.

The term “future transaction” or “futures contract” as used herein means a contract traded on a futures exchange for delivery of a specified amount of a commodity or security, or for settlement on a cash basis at a future date.

The term “futures price” as used herein means the price of a commodity or a security determined by public auction on a futures exchange or electronic medium.

The term “Index” as used herein means a compilation of the prices of several common entities into a single number.

The term “option” as used herein means the right, but not the obligation, to purchase or sell a specified amount of a commodity or security at a specified price within a specified period of time. An American style option is an option contract that may be exercised at any time between the date of purchase and the expiration date, and most exchange-traded options are American-style. A European style option is one that may only be exercised at its expiration, such that there can be no early assignment with this type of option.

The term “premium” as used herein refers to the price of an option contract, determined in the competitive marketplace, which the buyer of the option pays to the option writer (or seller) for the rights conveyed by the option contract.

The term “Index Option” as used herein means an option whose underlying entity is an index. Most index options are cash-based, meaning that there is no physical commodity or security that is traded.

The term “put option” as used herein means an options contract that gives the holder the right, but not the obligation, to sell a specified amount of a commodity or security at a specified price for a specific period of time in the future. For example, the right to sell commercial real estate, in a specific sector, at a specified price (per square foot, or meter).

The term “call option” as used herein means an options contract that gives the holder the right, but not the obligation, to buy a specified amount of a commodity or security at a specified price for a specific period of time in the future. For example, the right to buy commercial real estate, in a specific sector, at a specified price (per square foot, or meter).

The term “real estate statistics” as used herein means, any statistics that are measures of movement, risk or of any relevance to the underlying real estate markets. These statistics can include, but will not be limited to, sales prices, lease rates, rents, vacancy rates, capitalization rates, absorption rates, occupancy rates and any other statistically compiled data that exists to analyze price trends or behavior in the physical real estate market.

The term “strike price” or “exercise price” as used herein means the stated price per share for which the underlying security or commodity may be purchased (in the case of a call option) or sold (in the case of a put option) by the option holder upon exercise of the option contract, as defined in the terms of his option contract.

The term “exercise” as used herein means the act of taking advantage of the right to buy or sell the underlying futures contract at an agreed upon strike price.

The term “assignment” as used herein means the receipt of an exercise notice by an option writer (seller) that obligates him to sell (in the case of a call) or purchase (in the case of a put) the underlying security or to effect cash settlement at the specified strike price.

The term “expiration date” or “expiration time” as used herein means the day or time on which an option contract becomes void. Holders of options should indicate their desire to exercise, if they wish to do so, by this date.

The term “at-the-money option” as used herein means that the strike price of the option is equal to the market price of the underlying security or commodity.

The term “in-the-money option” as used herein means any option that has intrinsic value. For example, a call option is in the money if the underlying security or commodity is higher than the strike price of the call, and a put option is in the money if the security or commodity is below the strike price.

The term “out-of-the-money option” as used herein means any option that has no intrinsic value. For example, a call option is out-of-the-money if the strike price is greater than the market price of the underlying security or commodity, and a put option is out-of-the-money if the strike price is less than the market price of the underlying security or commodity.

The term “intrinsic value” as used herein means the value of an option if it were to expire immediately with the underlying stock at its current price, i.e., the amount by which an option is in the money. For call options, this is the difference between the stock or commodity forward or futures price and the strike price, if that difference is a positive number, and zero otherwise. For put options, this is the difference between the strike price and the stock or commodity forward or futures price, if that difference is positive, and zero otherwise.

The term “time value” as used herein means the amount of option premium that exceeds its intrinsic value.

The term “option price” as used herein means the premium that the buyer pays and the seller receives for transacting the option.

The term “theoretical value” as used herein means the price of an option, or a combination of options, as computed by a mathematical model. Option prices are derived typically from forward or futures prices, using a standard options pricing formula, such as the Black-Scholes options pricing formula, binomial option pricing formula, or a derivative of either.

The Black-Scholes option pricing formula, as described in Black, F. and Scholes, M., Options Pricing Formula, University of Chicago, 1973, prices European put or call options on a stock that does not pay a dividend or make other distributions. This option pricing formula assumes the underlying stock price follows a geometric Brownian motion with constant volatility. In the original option pricing formula published by Black and Scholes, values for a call price c and put price p are
c=sΦ(d₁)−xe^{-rt}Φ(d₂) and p=xe^{-rt}Φ(−d₂)−sΦ(−d₁), where

$${d}_{1} = \frac{log ( s / x ) + ( r + {σ}^{2} / 2 ) t}{σ \sqrt{t}}$$

and d₂=d₁−σ\sqrt{t}. Here, log denotes the natural logarithm, and:
s=the price of the underlying stock
x=the strike price
r=the continuously compounded risk free interest rate
t=the time in years until the expiration of the option
σ=the implied volatility for the underlying stock
Φ=the standard normal cumulative distribution function.

For example, consider a European call option on 100 shares of non-dividend-paying stock ABC. The option is struck at $55 and expires in 0.34 years. ABC is trading at $56.25 and has 28% (that is 0.28) implied volatility. The continuously compounded risk free interest rate is 0.0285%. Applying the formula for a call price, the option's market value per share of ABC is $4.56. Since the call is for 100 shares, its total value is $456. Of this, $125 is intrinsic value, and $331 is time value.

The term “Delta” as used herein is a value for the amount by which an option's price will change for a one-point change in price by the underlying entity. Call options have positive deltas, while put options have negative deltas. Technically, the delta is an instantaneous measure of the option's price change, so that the delta will be altered for even fractional changes by the underlying entity. For a call option Delta=Φ(d₁), and for a put option Delta=Φ(d₁)−1.

The term “Gamma” as used herein is a value for how fast or how much the Delta of an option changes as the underlying futures change. For both call and put options,

$$gamma = \frac{ϕ ( {d}_{1} )}{s σ \sqrt{t}} .$$

The term “Vega” as used herein is a value for how much an option will increase in value as the volatility rises. For both call and put options, Vega=sφ(d₁)\sqrt{t}.

The term “Theta” as used herein is a value for the rate at which an option loses its value as time passes, i.e., a measure of the rate of change in an option's theoretical value for a one-unit change in time to the option's expiration date. For a call option

$$Theta = - \frac{s ϕ ( {d}_{1} ) σ}{2 \sqrt{t}} - r x {ⅇ}^{- rt} Φ ( {d}_{2} ) ,$$

and for a put option

$$Theta = - \frac{s ϕ ( {d}_{1} ) σ}{2 \sqrt{t}} + rx {ⅇ}^{- rt} Φ ( - {d}_{2} ) .$$

The term “Rho” as used herein is a value of the option's sensitivity to changes in interest rates. For a call option rho=xte^{-rt}Φ(d₂), and for a put option rho=−xte^{-rt}Φ(d₂) where φ denotes the standard normal probability density function.

A binomial option pricing formula is used for calculating values and pricing options on American style options. The binomial model breaks down the time to expiration into potentially a very large number of time intervals, or steps. A tree of stock or commodity prices is initially produced working forward from the present to expiration. At each step, it is assumed that the stock or commodity price will move up or down by an amount calculated using volatility and time to expiration. This produces a binomial distribution, or recombining tree, of underlying stock prices. The tree represents all the possible paths that the stock price could take during the life of the option. At the end of the tree, i.e., at expiration of the option, all the terminal option prices for each of the final possible stock or commodity prices are known, as they simply equal their intrinsic values.

Next, the option prices at each step of the tree are calculated working backward from expiration to the present. The option prices at each step are used to derive the option prices at the next step of the tree using risk neutral valuation based on the probabilities of the stock or commodity prices moving up or down, the risk free rate and the time interval of each step. Any adjustments to stock prices (at an ex-dividend date) or option prices (as a result of early exercise of American options) are worked into the calculations at the required point in time. At the top of the tree, there is one option price remaining.

In a binomial model, the option has only two possible outcomes because the underlying stock or commodity has only two possible outcomes—up by a factor of u or down by a factor of d. The stock price at the end of the period is either Sᵤ=S(1+u) or S_{d}=S(1+d), where u and d are the rates of return on the stock or commodity and u and d can be different. At expiration, a call on the stock or commodity will be worth its intrinsic value, i.e.,
either Cᵤ=Max[0,S(1+u)−E]
or C_{d}=Max[0,S(1+d)−E]
Assume that u is high enough that the call will expire in the money and assume that d is low enough (negative) that the call expires out-of-the-money. Assume that d<r<u, where r is the risk-free interest rate. Note that the call price is not given in absolute terms but in terms of the underlying stock or commodity's price.

The formula is derived by constructing a risk less portfolio of stock or commodity and options. A risk less (no uncertainty) portfolio should earn the risk-free rate. The risk less portfolio, called the hedge portfolio, consists of h shares of stock and one written call, where h is the hedge ratio. The value of the portfolio is V=hS−C. At expiration, the value will be either Vᵤ=hS(1+u)−Cᵤ or V_{d}=hS(1+d)−C_{d}. If the portfolio is risk less, there should be no uncertainty in the value, i.e., Vᵤ=V_{d} regardless of the movement of S.

But since the portfolio is risk less, the future value of the portfolio should be V(1+r)=(hS−C)(1+r) as well, which should be equal to either Vᵤ or V_{d}, which are identical anyway. So, V(1+r)=Vᵤ and (hS−C)(1+r)=hS(1+u)−Cᵤ. Substituting the formula for h and solving for C gives the option pricing formula:

$$C = \frac{p {C}_{u} + ( 1 - p ) {C}_{d}}{1 + r}$$

where p=(r−d)/(u−d). The values of p and (1−p) could be interpreted as the probability of an upward movement in the stock or commodity price and (1−p) as the probability of a downward movement in the stock or commodity price. But no assumptions about the value of p are necessary for developing the formula. So, the current call price should be the present value of the weighted average of the two possible call prices at expiration.

The general principle of risk-neutral valuation states that the world can be assumed to be risk-neutral when pricing options. This is possible if the option pricing models is stated in terms of the underlying stock or commodity price rather than in absolute terms.

For example, assume that:
S=60
E=50
u=0.15
d=−0.20
r=0.10
   Note that the expiration value of the hedged portfolio will be the same regardless of the movement in the stock or commodity price.

At t=0 the value of the portfolio is 0.9048(60)−14.80=54.29−14.80=$39.49.

At t=1 the value of the portfolio will be 0.9048(69)−19=62.43−19.00=$43.43, if the stock or commodity price moves up 15%, or will be =0.9048(48)−0=43.43−0=$43.43, if the stock or commodity price moves down 20%.

Also, note that $43.43=39.49(1+0.10)=39.49(1+r). That is, since the hedged portfolio should be risk less, the return on the portfolio should be the risk-free rate, in this case, 10%. Note that, at t=0, the value of the call is greater than its intrinsic value of $10.

So, given a formula for what the price of the call should be, a trader can compare the market price to determine if the call is overpriced or underpriced, and whether the call should be sold or bought respectively.

The main advantage of the binomial model over the Black-Scholes model is that it can be used to accurately price American options. This is because it is possible with the binomial model to check at every point in an option's life (i.e., at every step of the binomial tree) for the possibility of early exercise (e.g., where, due to e.g. a dividend, or a put being deeply in the money the option price at that point is less than the its intrinsic value). Where an early exercise point is found, it is assumed that the option holder would elect to exercise, and the option price can be adjusted to equal the intrinsic value at that point. This then flows into the calculations higher up the tree and so on.

The binomial model basically solves the same equation, using a computational procedure that the Black-Scholes model solves using an analytic approach and in doing so provides opportunities along the way to check for early exercise for American options. The same underlying assumptions regarding stock or commodity prices underpin both the binomial and Black-Scholes models: that stock prices follow a stochastic process described by geometric Brownian motion. As a result, for European options, the binomial model converges on the Black-Scholes formula as the number of binominal calculation steps increases. In fact, the Black-Scholes model for European options is really a special case of the binomial model where the number of binomial steps is infinite. In other words, the binomial model provides discrete approximations to the continuous process underlying the Black-Scholes model. However, although the binomial model and the Black-Scholes model ultimately converge as the number of time steps gets infinitely large and the length of each step gets infinitesimally small, this convergence, except for at-the-money options, is anything but smooth or uniform.

To handle American option pricing in an efficient manner other models have been developed. The Roll, Geske and Whaley analytic solution can be used for pricing an American call on a stock paying discrete dividends. In addition, Black's approximation for American calls basically involves using the Black-Scholes model after making adjustments to the stock price and expiration date to take account of early exercise. Further, the Barone-Adesi and Whaley quadratic approximation is an analytic solution for American puts and calls paying a continuous dividend. Although a number of option pricing models are described herein for purposes of illustration, any suitable option pricing model may be used in conjunction with the present invention.

As described above, a method is provided for valuing futures, forward values and options on commercial real estate (or any other type of real estate) creates a vehicle for owners of commercial property (lessors), renters (lessees) of commercial property, holders of leases, speculators in commercial property, future renters (future lessees), future lessors, those who have financial exposure in terms of commercial real estate values and other interested parties; to ascertain current, forward, futures and option values for commercial real estate rates. It allows them to hedge (offset) risk or take on additional risk in terms of the commercial real estate market. It creates transparency (known, non-biased and published pricing) in a market that does not have current benchmark prices that are available to the public and accepted as the actual market prices. Although the present invention is particularly applicable to commercial real estate, it should be appreciated that it can also be applied to rural land (i.e., unimproved land); residential real estate, industrial real estate, or any other type of real estate or real estate statistics.

The creation of a market for the active trading of real estate and the method for valuing forwards, futures and options on commercial real estate (or any other type of real estate) derives from the establishment of a historical database. At first, a city, municipality, town, village or locality is broken down into sectors within which there is a high degree of correlation between (a) real estate (for example, commercial or industrial) leasing rates per square unit area, e.g., foot meter, acre, hectare, as the case may be, and/or (b) the price movement of different properties (e.g., class A, B or C properties or different classes as defined by compliers of data) within the same sector in square feet, meter, acre, or hectare on a percentage basis. It may be appropriate for a locality to have only one sector in some cases. In others, it may be appropriate for a city to be divided into many sectors, reflecting the fact that among the areas of that particular city there are stark differences, for example, in rates for leasing or in percent appreciation or depreciation.

In each sector, data are collected from a myriad of sources. These sources will include city, town, village or municipality records; known and licensed real estate broker's records, actual lease documents and any other sources that are bona fide and may be appropriate in terms of ascertaining real estate lease and sales rates, per square unit area, e.g., foot, meter, acre, hectare as appropriate. It is preferred that only free market properties are considered, thus excluding government regulated leases, such as rent-controlled, rent stabilized another such leases whose lease terms and rates are controlled in some measure by law. Furthermore, leases are in general standardized, such that variability in leases among such factors such as inclusion of taxes and utilities in lease rate, specific sublease rights or restrictions, and others, are stripped out.

The data include actual lease rates and prices for leases agreed upon between owners of properties and lessees of those properties for the period of those leases. For example, if a lease is for ten years in tenure at a fixed price, that lease will provide data only for the month in which the lease was agreed upon, as it was agreed upon at the current market at the time that the lease was entered into. However, if the lease provides for monthly or annual increases based upon a percentage or some other variable, the present value of that amount will be calculated and collected as data for that particular lease. The purpose of this data collection is to ascertain only the market lease rate value for the period in each data point. In this case, it is preferred that each month will be a data point, as that is the period when the lease was entered into at the then-current market.

The data are compiled in each sector for a set period, for example, the previous ten, fifteen, or twenty calendar years. The average price per square foot (or meter, acre, hectare, etc.) will then be calculated on either a weighted average basis (the sum of the number of square feet, meters, acres, hectares in a lease times the price per square foot or meter (or acre, hectare, etc.) divided by the total number of square feet, meters, acres, hectares) or a moving average or exponential moving average or some derivative thereof, which will yield the average price per square foot (or meter, etc) for that sector each month and year for the number of years. The current average price per square foot (or meter, etc.) will be the current month's data, which for this example will be calculated on a weighted average basis. This will be the value of the current cash index. A measure of historical variance or volatility will be applied in order to establish the historical variance or volatility of that particular sector. This process will be repeated for each and every sector in each city, municipality, town, village or locality where data are readily available.

Once data are collected, the results (for example, for all twenty years or two hundred and forty months) will be compiled into a series of data points. It is preferred that each month from inception until the current month is a single data point. The most recent point would be the current cash value of the index. When a complete set of data are collected in a sector for the entire time period, statistical tools will be utilized in order to smooth out the results and create a normal distribution of lease prices for each period (month and year) encompassing that period.

For example, if there were five leases entered into within a specific sector during the current month, the data would be as follows:
Lease 1: 100,000 Sq. feet at $46.00 for ten years at a constant rate
Lease 2: 100,000 Sq. feet at $48.00 for ten years at a constant rate
Lease 3: 100,000 Sq. feet at $50.00 for ten years at a constant rate
Lease 4: 100,000 Sq. feet at $52.00 for ten years at a constant rate
Lease 5: 100,000 Sq. feet at $54.00 for ten years at a constant rate
   If there were a sliding scale of increases in future years, the current lease value would reflect the present value based upon current interest rates.

Calculation of the index would be made on a weighted average basis, a moving average, an exponential moving average or some derivative thereof. One example of the calculation of the index for a specific sector is the sum of the square footage times the price per square foot divided by total square footage. In this example, the weighted average is computed as follows:

$$\frac{\begin{matrix}( 100 , 000 \times 46 ) + ( 100 , 000 ⨯ 48 ) + \\ ( 100 , 000 ⨯ 50 ) + ( 100 , 000 ⨯ 52 ) + ( 100 , 000 ⨯ 54 )\end{matrix}}{500 , 000} = \$50 per sq . ft .$$

If the most current month weighted average figure were $50.00 per square foot, the cash index would be trading at 50.00. Thus, in this example the index has a cash value of 50.00. Of course, the value of an index will change on a daily basis as new data are added, calculated and incorporated into the current month's index.

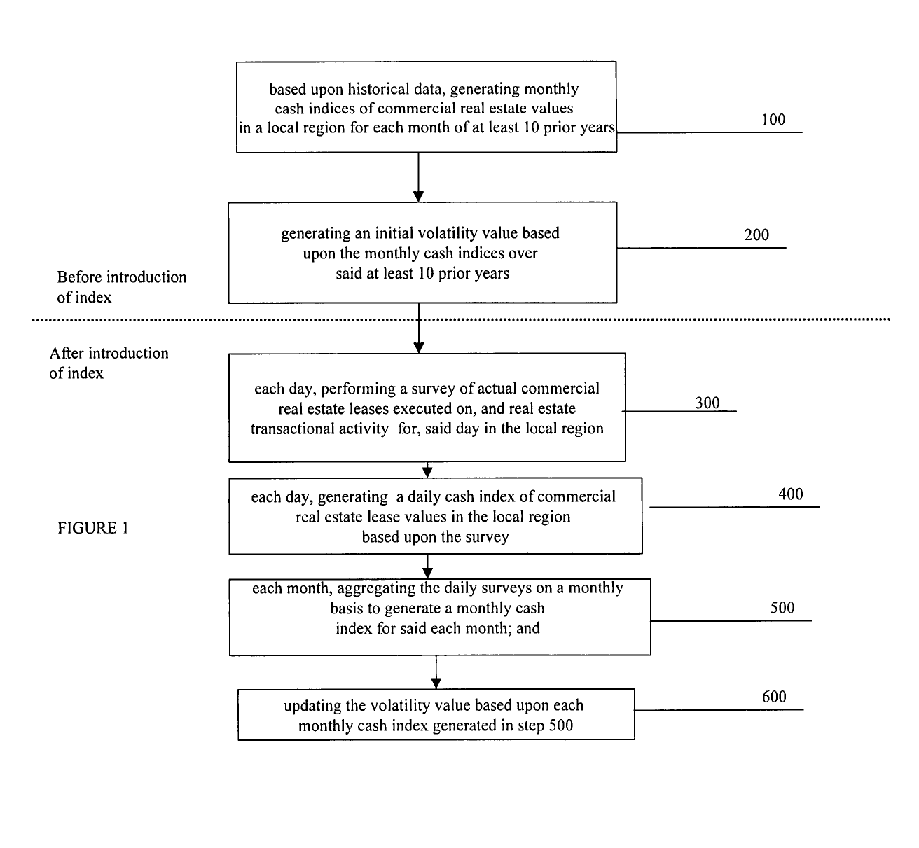

Preferably, the underlying daily lease data are generated by a Qualified Uniform Daily Cash Market Source. A general process for generating the daily cash index is illustrated in the flow chart of FIG. 1. As described above, prior to introduction of the index, monthly cash indices of commercial real estate values in the local region (sector) for each month of at least 10 prior years is generated based upon the historical data described above (step 100). An initial volatility value is then generated based upon the monthly cash indices over said at least 10 prior years. Then, when the index is introduced the cash market source conducts daily surveys of actual commercial real estate leases executed on that day in the sector (i.e., local region) and/or transactional activity in the sector on that day (step 300), and generates a daily cash index of commercial real estate lease values in the sector based upon the survey (step 400). Preferably, if the survey uncovers no transactions or transactional activity on a given day, the previous day's index value is used. The daily data are then aggregated on a monthly basis to generate a monthly cash index for said each month (step 500), and the volatility value is updated based upon the new monthly cash index (step 600). To ensure the integrity of the index, the daily survey should be conducted by the Qualified Uniform Daily Cash Market Source, which is an unbiased party without fiduciary interest in the cash marketplace. Although this cash market source can also generate the index itself, it is also possible to have the index generated by the exchange (or another separate entity) based upon the data received from the cash source.

Some additional real estate products relating to residential and commercial property that are available for indexing and trading are the following:

Absorption Rates, which are the amount of additional space that becomes occupied, and this can be gross or net; and

Capitalization Rates (Cap Rates): a calculation that reflects the relationship between one year's net operating income and the current market value of a particular property (or group of properties), which is designed to reflect the rate of return or yield of the investment.

It should be noted that although the system preferably aggregates the data to form monthly indices, the data can alternatively (or additionally) be aggregated in any periodic manner, e.g., weekly, biweekly, quarterly, biannually, annually, etc. In addition, although the system has been described above in the context of a single local region, it should be appreciated that in other embodiments of the present invention, the indices for the local regions (sectors) can be aggregated to form regional, statewide, national, or even global indices.

In a preferred embodiment of the present invention, the individual lease values are weighted according to building class. In this regard, one of ordinary skill in the art will appreciate that commercial real estate is commonly divided into Class A buildings, Class B buildings, and Class C buildings, with space in Class A buildings generally renting at a higher price than space in Class B buildings, and Class B buildings generally renting at a higher price than space in Class C buildings. The building classification is generally based upon the services (e.g., cleaning, door man, porters) provided in the building, but may also be affected by the location (e.g., avenue vs. side streets) or the physical structure and fixtures provided (e.g., elevators, lobby, etc). Nevertheless, there is general agreement among real estate agents and building owners regarding the building class of any given building. The weight accorded to each class could be assigned on a variety of bases. For example, it could be weighted as a function of the percentage of overall commercial space in the local region having each building class. As another example, it could be weighted according to a perceived volatility of a building class. For example, it is often theorized that Class A buildings are less sensitive to a downturn in the lease market than Class B and Class C buildings.

In alternative embodiments, real estate transactions can be weighted according to other classifications. For example, residential real estate transactions could be weighted according to room classifications, e.g., studio, one bedroom, two bedroom, three bedroom, four bedroom, etc.

Forward prices would preferably be determined on a principal to principal basis between parties wishing to secure the forward value of space in the future both on the lessee and lessor side. When each party to a transaction agrees upon a price, the terms of the transaction would settle on a cash basis on the settlement date against the cash index representing the agreed upon sector. As an example, a forward transaction entered into for five years at a price of $60 per square foot in the agreed upon sector would settle five years hence at the cash value of the index on that date. If the cash index were $70 per square foot on that date, the seller would pay the buyer $10.00 per square foot in settlement of the transaction. The parties to this transaction could be owners of property, renters of property, speculators, hedgers or any interested parties. In this way, the index provides a benchmark price as well as a transparent and unbiased market reflecting actual rates achieved in the underlying market. In other words, on the settlement date, the value of the daily cash index converges with the actual value of the real estate that is being hedged.

In one preferred embodiment, futures prices will be determined by open-outcry in a commodity pit or electronic matching of bids and offers. Order of various types such as market orders, spread orders, limit orders, market if touched orders, buy or sell on close orders, buy or sell on opening orders, day orders, market on opening or closing orders, resting orders, scale orders, stop orders, stop-limit orders and various other types of orders will be placed, either with brokers in a trading pit or ring or via an electronic marketplace. Sellers and buyers will come to the market and show their interest to either buy or sell a certain number of square feet of commercial (or other type of) real estate in a given sector for a specific future date. These transactions will be facilitated via standard trading platforms that now exist in all equity, debt and commodity markets.

Contract specifications will be determined preferably in terms of months and years in the future and number of square feet or meters (or acre, hectare, etc.) per contract. Futures contracts are standardized in terms of settlement terms (the dates and times that the contract will settle on a cash basis and against which index it will settle in each case) and contract size (the amount of the real estate contained in each contract). The futures contracts will represent the future value of the index as determined by buyers and sellers of futures.

The buy orders, or bids, and the sell orders, or offers, will be matched and the transactions will be executed. Preferably, trades will be executed either on exchanges where floor brokers or locals will execute orders for customers and locals will execute order for their own accounts in a trading pit, or ring, or via electronic trading platforms. The prices at which the futures and futures options transactions trade are preferably published, and the trades are preferably cleared through a clearinghouse, as is done with stocks, bonds and commodities that trade on exchanges. Exchanges will control original and variation margin requirements as well as position limits. There will be data created in terms of volume of transactions, the high price and low price each index trades at daily. Additionally, there will be data on open-interest (the number of open buy and sell contracts existing in the marketplace for the futures contract). This will create a fully transparent market for commercial real estate (and all other types of real estate as outlined above) in each sector. The orders may be transmitted to the floor brokers or exchange in any manner. It is contemplated, however, that orders can be placed using software platforms (e.g., client based software, or web based software), as is commonly done with stocks and commodities.

Options currently exist in many long-term commercial leases. Options on commercial real estate leases create a hedging and valuation tool for existing options that are embedded in leases. They also create a tool, which will serve to allow those interested parties to protect themselves from price movements. They also will create the opportunity for those parties who wish to speculate on the movement of commercial real estate lease rates (or other type of real estate transaction) over time, as will the forward and futures market for commercial real estate leasing (or other type of real estate transaction). Option prices will be derived from forward or futures prices, using an appropriate option pricing formula or a derivative thereof.

The option, either a put option or a call option, will be either on the forward value in the over-the-counter market or, on the futures exchange, in the form of a futures option contract. The futures options will be traded on a futures exchange. The options can be at-the-money, or trading at the current forward or futures price. They can be in the money, where the current futures price gives rise to intrinsic value. Intrinsic value is the in-the-money portion of an option (a put option with a strike price of $50 per sq. ft. where the underlying market is trading at $40 per sq. ft. has $10 per sq. ft. of intrinsic value; a call option with a strike price of $50 per sq. ft. where the underlying market is currently trading at $70 per sq. ft would have $20 per sq. ft. of intrinsic value.) The options can be out-of-the-money, where there is no intrinsic value, just time value. The strike price is the price at which the option can be exercised or settled against.

Preferably, all of the options, forwards and futures would settle on a cash basis on the date of settlement against the appropriate index. The premium is the price that the seller receives and the buyer pays for the rights inherent in the option. When an option is traded, the buyer pays a premium and the seller receives a premium that is mutually agreed upon. The premium is generally paid and received within two business days. Cash settled options of forwards and of futures for commercial real estate allows those parties with current exposures to hedge their risk. It also allows those interested parties who wish to either take risk or mitigate risk an opportunity to do so in a transparent and nonbiased marketplace.

The system in accordance with the embodiments of the present invention provides many parties with the opportunity to enter into hedge, speculative, spread or arbitrage positions in order to mitigate risk or take on additional risk on a financial cash-settlement basis. Many different type of parties will benefit from the establishment of the system described herein.

For example, owners of real estate, i.e., owners of commercial property (or any other real estate as outlined above), will be able to hedge the future rents and lease rates, or sales prices of the property that they own within a given sector. They will have the ability to protect themselves from a declining market in terms of selling forwards, futures or call options or purchasing put options if their property or properties are not yet rented or their leases are maturing. They will also have the ability to cover call options granted by purchasing back call options within the sector that they may have granted them to lessees. There are many other uses that owners of property may employee via this system.

In addition, renters or lessees of commercial property (or any other real estate as outlined above) will be able to hedge the future rents, lease rates or purchase prices of property that they are either currently renting or that they anticipate renting within a given sector. They will have the ability to protect themselves from an appreciating market in terms of buying forwards, futures or call options or selling put options if the property of their choice is not yet available to them or if they are not in a position to secure a lease or purchase. They will also have the ability to value and hedge call options granted to them by lessors or landlords within the sector that they may have embedded in their current leases. There are many other uses that renters of property may employ via this system.

Holders of options on commercial property (or any other real estate as outlined above) will also have the ability to value and offset, if they wish, these positions that are created by the fact that they are holders of options to renew a lease or in some cases purchase a property at a certain price for a certain maturity. There are many other uses that holders of these options may employ via this system.

Similarly, grantors of options on commercial property (or any other real estate as outlined above) will also have the ability to value and offset, if they wish, these positions that are created by the fact that they have granted options to renew a lease or in some cases to sell a property at a certain price for a certain maturity. There are many other uses that grantors of these options may employ via this system.

Furthermore, developers of commercial property (or any other real estate as outlined above) will have the ability to sell forwards, futures or call options or purchase put options in order to guaranty the current market lease rates or rents. This will aid them in terms of negotiating financing arrangements with banks and financiers. It will strip the market risk out of the equation when a provider of financing looks at the potential and assumed cash flow of a property and the developer's ability to perform on their loans or equity investments in their properties that are under construction or being contemplated. There are many other uses that developers of these properties may employ via this system.

Other parties that will benefit from the establishment of the system described herein are businesses seeking expansion that have anticipated additional space requirements in the future. Such businesses will have the ability to buy futures, forwards or call options or sell put options in order to hedge themselves against an appreciation of price in the market sector that they plan to expand in. Conversely, businesses seeking contraction that have anticipated less space requirements in the future will have the ability to sell futures, forward or call options or purchase put options in order to hedge themselves against a declining market in terms of price in the market sector that they plan to contract in. There are many other uses that businesses seeking expansion or contraction may employ via this system.

In addition, any party that has exposure to commercial real estate lease rates (or any other real estate exposure as outlined above) will have the ability to offset risk by hedging utilizing the forward, futures and options markets via this system.

Similarly, any party that wishes to take on risk and speculate as to the direction of commercial real estate lease rates (or any other real estate rates whether sales or leasing) will be able to do so via employing this system. This system will give the party the ability to go long or short in specific sectors and the ability to employ that party's market view as to the direction of price of the underlying market. The party can go long without purchasing actual physical property, and the party can go short, where no mechanism for shorting this market now exists.

Furthermore, arbitrageurs and spread traders will have the ability to spread risk from one sector against another using this system. They will also have the ability to profit from markets that are mispriced via option or spread trades. Additionally, arbitrageurs and spread traders will have the ability to build positions utilizing other futures, forwards and options trades that exist in markets that are highly correlated with the real estate markets, such as the markets for interest rates, inflation, currency and others that are related to the economic cycle which affects these markets. There are a myriad of uses for arbitrageurs and spread traders via this system.

The system provides these and other parties with the opportunity to enter into many different type of transactions based upon the establishment of the system described herein, as discussed herein below, such as hedging transactions, swaps, forward or future transactions, options transactions and speculative transactions.

Hedging transactions would be effected by a hedger either buying or selling forwards, futures and/or options of the index in the sector in which they have exposure. For example, if a developer of land in a specific sector needed to guarantee the current market lease rate of $40 per square foot in order to secure a good rate for financing his project, he or she could go to either the forward, futures or options market and sell forward or futures or purchase put options with a strike price of $40 per square foot in that specific sector. If he were building a property with 100,000 square feet, he would hedge 100,000 square feet at $40. Therefore, he would satisfy his lenders request to “lock in” the current market rates for the future. Then, if prices were to rise to $50 per square foot in the future, the developer would lease the property at the current market rate of $50 to lessees, and he would either close out his hedge by purchasing back his short position in the forward or futures market or sell out his put option. Thus, the loss would be deducted from the $50 that he received from the lessee, giving him a net of at least $40 per square foot. On the other hand, if prices were to decline to $30 per square foot, the developer would lease the property to lessees at the current market of $30 per square foot, and then either close out his hedge by purchasing back his short position in the forward or futures market or sell out his put option. Thus, he would receive a $10 profit from his hedge position and would net at least $40 per square foot, which would satisfy his lender. This is just one simple example of a hedge transaction using this system, and there are a myriad of other possibilities for hedgers via this system.

One hedge possibility is a homeowner's hedge for residential real estate. For example, a homeowner or owner of a piece of real estate owns a property that has appreciated significantly over the life of his or her ownership; assume the homeowner purchased the house (approximately 3,000 square feet) for $100,000, and the current market value of the house is $400,000. The homeowner anticipates selling the property in two years. The owner will have the opportunity to lock in the current market value by selling futures, forwards or call options on futures or forwards or by purchasing put options on futures or forwards representing 3,000 square feet in the appropriate sector, thereby guaranteeing the current market price. If the current market for the sector is $133.33 per square foot ($400,000 divided by 3000 square feet), the owner would have the ability to sell futures or forwards at $133.33 per square foot or purchase a put option with the strike price of $133.33 per square foot (or some value close to that) for that specific sector for the square footage that he or she wishes to hedge. If the owner buys the option, he or she would pay a premium. If the owner sold futures or forwards, the property itself could be used as collateral for the transaction.

If the property, over the life of the hedge, depreciates in value the owner will have positive equity in their account (in terms of the hedge) as they have sold the forward or future at $133.33 and the value of the sector is now below that. If the property were to appreciate, the owner would be in a negative equity situation and would owe money against the hedge. However, as a result of pledging the property as collateral for the hedge, the party with whom the hedge was transacted (a bank or broker) would have a claim against the property itself (as it would have been pledged as collateral), thus protecting itself from the credit risk inherent in the transaction. When the owner sells the property, he buys back his or her hedge (or sells out the put option), thus liquidating the hedge and achieving the hedged price of $400,000 (or $133.33 per square foot) for the property. In this example, the owner of the property hedged him or herself against a loss in value of the property owned.

The futures, forwards and option markets could also be used by those future owners of property who wish to protect themselves from an appreciating market by purchasing futures, forwards and/or options in the appropriate sector for the appropriate amount of space.

Another hedge possibility is an industrial hedge for a manufacturer who sees business growing. For example, at the current levels of growth, the manufacturer assumes that he or she will need an additional 100,000 square feet of industrial space in a specific sector in the coming years. Industrial space is currently $15 per square foot. The manufacturer will have the ability to purchase futures, forwards or call options on futures or forwards or by selling put options on futures or forwards representing 100,000 square feet of industrial space in the appropriate sector, thereby guaranteeing him or herself a price of $15 per square foot or the current market price. The converse is true for a business with an interest in industrial real estate that is contracting.

Similarly, a different possibility is a land hedge, wherein a farmer or other land user of owner will have the ability to hedge his land. Assume that land in a certain farming sector is trading at $2000 per acre. Generally, land will be more fruitful during a good growing season and less fruitful during a poor growing season, and land prices will fluctuate according to how useful the land actually is. Therefore, the underlying market for this type of property will rise and fall in direct correlation to the utility of the land itself. Farmers and other users of land would have the ability to buy and sell using futures, forwards and options on the appropriate sectors. They could sell when they see their businesses contracting or buy when they see their businesses expanding. They would have the ability to hedge their underlying crops, which are grown on the land via traditional commodity hedging markets or via their use of futures, forwards and options on the property itself. Other land owners who use vacant land for a variety of reasons, such as the government (who owns the largest amount of vacant land), mining and exploration companies in all commodities and any other users of land, will have the ability to buy and sell futures, forwards and options on their holdings or their desired future holding in specific sectors.

Another type of transaction that would be made possible via this system are swap transactions, which utilize a combination of forwards, futures, options on forwards and futures options as well as actual physical real estate transactions. There are many types of swap transactions that could arise via the indices and the use of the forward, futures and options markets. Swaps could be arranged from one sector to another for property owners, buyers or renters who have interests in various sectors. Swap transactions will allow a tremendous amount of flexibility for those who want to mitigate risk or take on additional risk vis-à-vis the real estate markets in the sectors represented by the indices.

For example, a developer is building his project, and the cost of land, construction and, all related costs is $32 per square foot in a sector, which is represented by an index. The developer has a group of investors who are looking to invest with the developer the $32 per square foot and are looking for a return on their investment with a limited amount of risk. Let's say that it will take one year for the project from inception to completion. The investors will be very happy to risk $2 to have a profit potential of $18 per square foot on the project in the next year, and will also be happy if the project is finished and they could start collecting their principle and interest back on their investment. One possibility is that the developer could go to a bank or a financial institution and enter into a swap transaction, whereby he would purchase put options on an index representative of the sector in which the property was being constructed with a strike price of $30 per square foot and sell call options with a strike price of $50 per square foot on the same sector. In one year's time, the project is complete and the developer leases his space to lessees at the current market. If the market at that time is below $30, the developer has protected his investors with his purchase of the put option. If the market is above $50, he can sell his property in the physical market and close out his hedge, locking in the $18 profit for his investors. A swap transaction, in this case, has allowed the developer to hedge the downside without giving up the upside of his investors' expectations for profit on the project.

Another transaction enabled by this system is a forward or future transaction, which will be utilized and will be settled off the index for the sector in which the transaction was initiated. Forward and/or futures transactions will be utilized by many market participants in order to mitigate or take on additional risk in the real estate market. For example, a potential lessee of a property who anticipates that he or she will be needed 100,000 square feet of space in a specific sector in one years time will initiate a hedge in that sector by either buying futures or forwards in that sector. If the current market price for the hedge is $40 per square foot, he or she will go long futures or forward at $40 per square foot. In one year's time, if the price is $30 per square foot, he or she will lease the property at $30 and close out his hedge by selling his futures or forward position, thus losing $10 per square foot, such that the net cost for the property is $40 per square foot. If, in one year's time, the price per square foot rises to $60 per square foot, he or she will lease in the physical market at $60 per square foot and then liquidate the hedge by selling out the forward or futures positions at $60 per square foot, thus gaining $20 per square foot, such that the net cost for the property is $40 per square foot. In both cases, the lessee has achieved the goal of leasing the space at $40 per square foot.

Options transactions will be utilized and will be settled via the index for the sector in which the option transaction was initiated. For example, if a current landlord has granted options to many of his or her tenants, and her or she believes that the market will to appreciate in price over the coming months and years when those options were coming due, he or she could go to the options market for the specific sector in which he or she granted those call options and buy them back, thus covering his or her risk. If the call options were exercised by his tenants because the market price went up, he would be able to close out his options position in order to recoup the opportunity loss that would have resulted if this methodology did not exist. There are many other applications for utilizing the options in order to mitigate or take on additional risk.

This system will also create an active and liquid market for speculation in real estate. Today, there is no way for anyone to go short the real estate market, and this system creates that mechanism. Speculative transactions will allow market participants and those interested parties to profit or lose from their views as to the real estate market's movements. The speculator will be able to position himself or herself, regardless of whether his/her view is that the market is going to appreciate, depreciate or simply stay the same. If they wish to take a view that the market is going to appreciate, they can buy forwards, futures and/or call options, or sell put options. If they wish to take a view that the market is going to depreciate, they can sell forwards, futures or call options or purchase put options. If they wish to take a view that the market is going to stay the same in terms of price in a specific sector, they can sell put and call options and earn the premium if they are correct in their view. This system creates the ability for a speculator to take a market view, which currently does not exist.

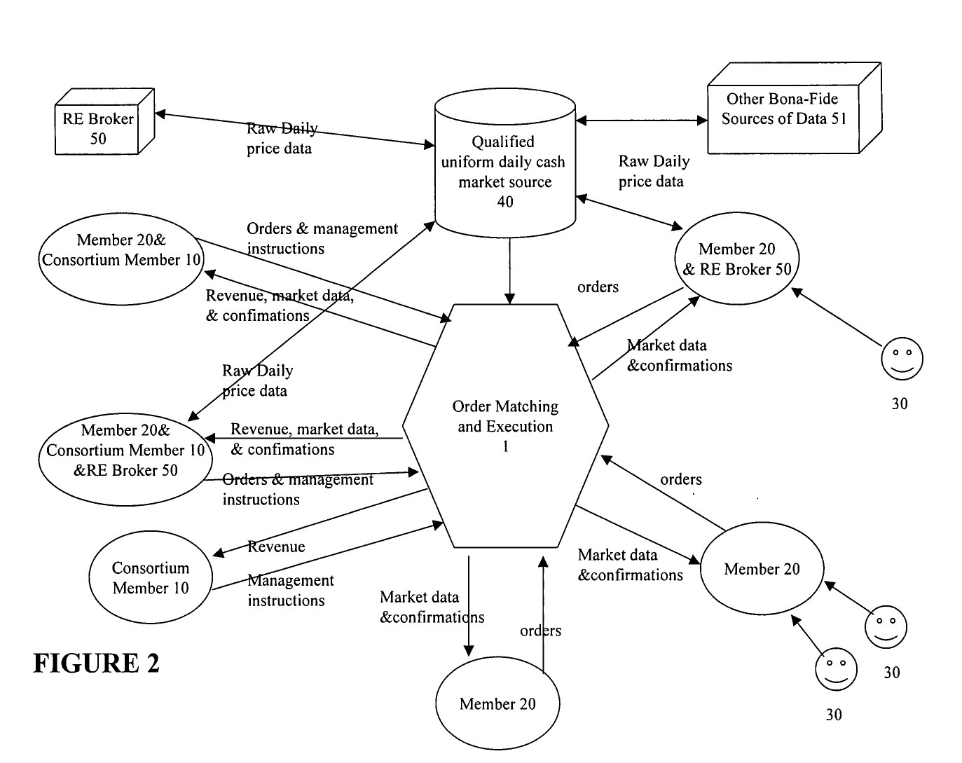

In accordance with another embodiment of the present invention, an exchange and method for creating an exchange is provided. FIG. 2 shows an exchange in accordance with this embodiment. Unlike conventional exchanges, such as gold futures, which derived from an organic market in futures, an exchange in interests in real estate leases has no underlying market. Referring to FIG. 2, in accordance with an embodiment of the present invention, an exchange 1 is formed by obtaining a group of investors 10 (or consortium members) to invest in the formation of the exchange. To facilitate the success of the exchange, the investors are selected from potential users of the exchange who have expertise and knowledge of the market for the commodities. Preferably, the investors are selected from the finance industry, the real estate industry, the banking industry and/or any other knowledgeable parties because, for the reasons outlined above, each of these industries can be expected to use and benefit from the exchange, and each have expertise and knowledge that would be valuable in creating and running the exchange. Once the consortium members invest in the exchange, they will have an incentive to use the exchange, thereby facilitating liquidity and its success. Moreover, with major players from banking, real estate, and finance using the exchange, the remaining players in these industries will have a great incentive to use the exchange themselves.

As with conventional exchanges, the exchange 1 may also sell “seats” or grant privileges on the exchange to members 20. In return for the membership fee, the members 20 have the exclusive right to buy and sell contracts or trade at preferential rates on the exchange 1. The consortium members 10 may, or may not, also be members 20. As with conventional exchanges, the members 20 frequently trade on behalf of third parties 30, such as brokers, individuals, companies, institutions, and the like. The exchange 1 provides order matching and trade execution for buy orders and sell orders generated by the members 20 in the same manner as conventional exchanges. The members send buy orders and sell orders to the exchange 1, the exchange 1 matches buy orders with sell orders in a conventional matter, executes the trade, reports the trade as required by government regulations, and then sends confirmations of each trade executed to the respective buyer (i.e., the member 20 which generated the buy order) and seller (i.e., the member 20 which generated the sell order). Preferably, the members 20 transmit buy/sell order to the exchange, and receive trade confirmations from the exchange, electronically via either software resident on the member's computers or via web-based software. It is also contemplated that the third parties 30 may communicate electronically with the members 20 in the same manner.

The exchange 1 also transmits market data to the members 20, also in a conventional manner. The market data includes, inter alia, bid and ask prices, as well as data regarding the daily cash index. The daily cash index is generated by a qualified uniform daily cash market source 40 as described above. In this regard, the source 40 obtains its daily information regarding real estate leases (and/or other types of real estate data) from, for example, real estate brokers 50. It should be noted that the consortium members 10 and the members 20 may also be real estate brokers 50 and other bona fide sources of data 51. The consortium members 10, as the owners of the exchange 1, set the rules and procedures of the exchange. In addition, as owners of the exchange, the consortium members receive a percentage of the revenue generated by the exchange, including, for example, a percentage of trade execution fees, membership fees, licensing fees for transmission of the market data, revenue from sales of software, etc.

Although the above-referenced exchange and method of forming an exchange is preferred, it should be appreciated that conventional exchanges and other trading systems can alternatively be used to generate and process buy and sell orders in accordance with the present invention.

In accordance with other embodiments of the present invention, the daily cash index is based, not on real estate transactions, but rather, on other real estate data, such as real estate vacancy rates, hotel occupancy rates, hotel room rates, data on new commercial or residential construction, etc.

For example, in accordance with another embodiment of the present invention, a method for matching buy and sell orders is provided which includes the steps of: maintaining a daily cash index of hotel room occupancy (or vacancies) for a local region; creating a trading instrument representative of an interest in hotel room occupancy (or vacancies) in the local region, wherein a cash settlement of the trading instrument is a function of the daily cash index on the date of said cash settlement; generating a plurality of buy orders relating to the instrument; generating a plurality of sell orders relating to the instrument; and matching the buy and sell orders to determine a purchase and sale of the instrument.

In accordance with another embodiment of the present invention, a method for matching buy and sell orders is provided which includes the steps of: maintaining a daily cash index of hotel room rates for a local region; creating a trading instrument representative of an interest in hotel room rates in the local region, wherein a cash settlement of the trading instrument is a function of the daily cash index on the date of said cash settlement; generating a plurality of buy orders relating to the instrument; generating a plurality of sell orders relating to the instrument; and matching the buy and sell orders to determine a purchase and sale of the instrument.

Some additional real estate products relating to hotels that are available for indexing and trading are the following:

RevPar (Revenue per room): a calculation that reflects gross revenue per room, in other words, occupancy rates muliplied by average room rates; and

ProfPar (Profit per room): a calculation that reflects operating profit per year over the daily available rooms per year.

In accordance with another embodiment of the present invention, a method for matching buy and sell orders is provided which includes the steps of: maintaining a daily cash index of real estate vacancy rates for a local region; creating a trading instrument representative of an interest in real estate vacancy rates in the local region, wherein a cash settlement of the trading instrument is a function of the daily cash index on the date of said cash settlement; generating a plurality of buy orders relating to the instrument; generating a plurality of sell orders relating to the instrument; and matching the buy and sell orders to determine a purchase and sale of the instrument.

These methods of trading interests in real estate occupancy (or vacancy) rates, hotel room rates and hotel occupancy (or vacancies) can be implemented and traded in the manner described above with regard to real estate lease rates. As such, they can be traded as futures contracts, forward transactions, options, options on futures contracts, and options on forward transactions, and can be used as hedging transactions, swap transactions, and for speculation.

With regard to the methods for trading interests in hotel room rates and hotel vacancies, the daily cash index is preferably weighted according to hotel classes, wherein the hotel classes include at least a two star hotel class, a three star hotel class, and a four star hotel class.

As described above, in accordance with certain embodiments of the present invention, methods for trading interests in real estate statistics are provided, comprising the steps of: maintaining a daily cash index of real estate values for a local region based on real estate statistics; creating a trading instrument representative of an interest in real estate in the local region, wherein a cash settlement of the trading instrument is a function of the daily cash index on the date of said cash settlement; generating a plurality of buy orders relating to the instrument; generating a plurality of sell orders relating to the instrument; and matching the buy and sell orders to determine a purchase and sale of the instrument. These methods of trading interests in real estate statistics can be implemented and traded in the manner described above with regard to real estate lease rates. As such, they can be traded as futures contracts, forward transactions, options, options on futures contracts, and options on forward transactions, and can be used as hedging transactions, swap transactions, and for speculation.

It will be understood that the foregoing description is illustrative only and that one of ordinary skill and expertise in the art will recognize various modifications which do not depart from the spirit and scope of the invention that are to be limited solely by the claims.

What is claimed is:

1. A method for matching buy and sell orders, comprising the steps of:
maintaining a daily cash index of real estate values for a local region based on real estate transactional activity and real estate transactions;
creating a trading instrument representative of an interest in real estate in the local region, wherein a cash settlement of the trading instrument is a function of the daily cash index on the date of said cash settlement;
generating a plurality of buy orders relating to the instrument;
generating a plurality of sell orders relating to the instrument; and
matching the buy and sell orders to determine a purchase and sale of the instrument.

2. The method of claim 1, wherein the trading instrument is a futures contract.

3. The method of claim 1, wherein the trading instrument is a forward contract.

4. The method of claim 1, wherein the trading instrument is an option on a futures contract.

5. The method of claim 1, wherein the trading instrument is an option on a forward contract.

6. The method of claim 1, wherein each day's daily cash index is generated as a function of a survey of actual real estate transactions executed on said day.

7. The method of claim 6, wherein the real estate transactions are real estate leases.

8. The method of claim 6, wherein the daily cash index is calculated on a weighted average basis.

9. The method of claim 6, wherein the daily cash index is calculated on a moving average basis.

10. The method of claim 6, wherein the daily cash index is calculated on an exponential moving average basis.

11. The method of claim 8, wherein the daily cash index is weighted according to building classes, wherein the building classes include at least Class A building, Class B buildings, and Class C buildings.

12. The method of claim 1, wherein the daily cash index is aggregated on a monthly basis to provide a monthly index value.

13. The method of claim 1, further comprising generating a volatility value of the daily cash index, said volatility value being a function of a historic performance of the daily cash index.

14. The method of claim 13, wherein the historic performance is a function of aggregated monthly values of the daily cash index over a plurality of years.

15. A method for trading futures contracts in real estate, comprising the steps of:
a. maintaining a daily cash index of real estate values for a local region based upon real estate transactional activity and real estate transactions;
b. creating a futures contract representative of an interest in real estate in the local region, the futures contract having a settlement date, wherein a cash settlement of the futures contract is a function of the daily cash index on the settlement date;
c. receiving a plurality of buy orders relating to the futures contract;
d. receiving a plurality of sell orders relating to the futures contract;
e. matching the buy and sell orders to determine a purchase and sale of the futures contract.

16. The method of claim 15, wherein the daily cash index is aggregated on a monthly basis to provide a monthly index value.

17. A method for providing indices for commercial real estate lease values, comprising:
a. each day, performing a survey of actual commercial real estate leases executed on said day and commercial real estate lease transactional activity for said day in a local region;
b. each day, generating a daily cash index of commercial real estate lease values in the local region based upon the survey;
c. each month, aggregating the daily surveys on a monthly basis to generate a monthly cash index;
d. generating a volatility value based upon the monthly cash indices over a plurality of years.

18. The method of claim 17, wherein the daily cash index is calculated on a weighted average basis.

19. The method of claim 17, wherein the daily cash index is calculated on a moving average basis.

20. The method of claim 16, wherein the daily cash index is calculated on an exponential moving average basis.

21. The method of claim 18, wherein the daily cash index is weighted according to building classes, wherein the building classes include at least Class A building, Class B buildings, and Class C buildings.

22. A method for providing indices for real estate transaction values, comprising:
a. each day, performing a survey of actual real estate transactions executed on said day, and real estate transactional activity for said day, in a local region;
b. each day, generating a daily cash index of real estate transaction values in the local region based upon the survey.

23. A method for matching buy and sell orders, comprising the steps of:
maintaining a daily cash index of real estate values for a local region based on real estate transactional activity;
creating a trading instrument representative of an interest in real estate in the local region, wherein a cash settlement of the trading instrument is a function of the daily cash index on the date of said cash settlement;
generating a plurality of buy orders relating to the instrument;
generating a plurality of sell orders relating to the instrument; and
matching the buy and sell orders to determine a purchase and sale of the instrument.

24. The method of claim 22, wherein the daily cash index is calculated on a weighted average basis.

25. The method of claim 22, wherein the daily cash index is calculated on a moving average basis.

26. The method of claim 22, wherein the daily cash index is calculated on an exponential moving average basis.

27. The method of claim 24, wherein the daily cash index is weighted according to building classes, wherein the building classes include at least Class A building, Class B buildings, and Class C buildings.

28. The method of claim 22, wherein the real estate transactions and real estate transactional activity are for commercial real estate leases.

29. The method of claim 22, wherein the real estate transactions and real estate transactional activity are for residential real estate leases.

30. The method of claim 22, wherein the real estate transactions and real estate transactional activity are for rural land real estate leases.

31. The method of claim 22, wherein the real estate transactions and real estate transactional activity are for industrial real estate leases.

32. A method for providing indices for real estate transaction values, comprising:
a. based upon historical data, generating monthly cash indices of real estate values in a local region for each month of at least 10 prior years;
b. generating a an initial volatility value based upon the monthly cash indices over said at least 10 prior years;
c. each day, performing a survey of actual real estate transactions executed on said day, and real estate transactional activity for said day, in the local region;
d. each day, generating a daily cash index of real estate transaction values in the local region based upon the survey;
e. each month, aggregating the daily surveys on a monthly basis to generate a monthly cash index for said each month; and
f. updating the volatility value based upon each monthly cash index generated in step

33. A method for providing indices for commercial real estate lease values, comprising:
a. based upon historical data, generating monthly cash indices of commercial real estate values in a local region for each month of at least 10 prior years;
b. generating a an initial volatility value based upon the monthly cash indices over said at least 10 prior years;
c. each day, performing a survey of actual commercial real estate leases executed on said day and commercial real estate transactions for said day in the local region;
d. each day, generating a daily cash index of commercial real estate lease values in the local region based upon the survey;
e. each month, aggregating the daily surveys on a monthly basis to generate a monthly cash index for said each month; and
f. updating the volatility value based upon each monthly cash index generated in step.

34. The method of claim 33, wherein the daily cash index is calculated on a weighted average basis.

35. The method of claim 33, wherein the daily cash index is calculated on a moving average basis.

36. The method of claim 33, wherein the daily cash index is calculated on an exponential moving average basis.

37. The method of claim 34, wherein the daily cash index is weighted according to building classes, wherein the building classes include at least Class A building, Class B buildings, and Class C buildings.

38. A method of operating an exchange, comprising:
a. at a daily cash market source,
i. each day, performing a survey of actual commercial real estate transactions executed on said day and commercial real estate transactional activity for said day in a local region;
ii. each day, generating a daily cash index of commercial real estate transaction values in the local region based upon the survey;
b. at an exchange, creating a trading instrument representative of an interest in real estate in the local region, wherein a cash settlement of the trading instrument is a function of the daily cash index on the date of said cash settlement;
c. at each of a plurality of exchange members, generating a plurality of buy orders and a plurality of sell orders for the trading instrument; and
d. at the exchange,
i. matching the buy and sell orders to determine a purchase and sale of the instrument, each purchase having a purchase price paid by its corresponding buy order and each sale having a sale price paid to its corresponding sell order;
ii. sending a portion of each purchase price to each of a plurality of investors in the exchange.

39. A method for providing indices for commercial real estate transaction values, comprising:
a. each day, performing a survey of commercial real estate transactional activity on said day in a local region;
b. each day, generating a daily cash index of commercial real estate transaction values in the local region based upon the survey;
c. each month, aggregating the daily surveys on a monthly basis to generate a monthly cash index;
d. generating a volatility value based upon the monthly cash indices over a plurality of years.

40. A method of operating an exchange, comprising:
a. at a daily cash market source,
i. each day, performing a survey of actual commercial real estate leases executed on said day, and/or commercial real estate transactional activity for said day, in a local region;
ii. each day, generating a daily cash index of commercial real estate lease values in the local region based upon the survey;
b. at an exchange, creating a trading instrument representative of an interest in real estate in the local region, wherein a cash settlement of the trading instrument is a function of the daily cash index on the date of said cash settlement;
c. at each of a plurality of exchange members, generating a plurality of buy orders and a plurality of sell orders for the trading instrument; and
d. at the exchange,
i. matching the buy and sell orders to determine a purchase and sale of the instrument, each purchase having a purchase price paid by its corresponding
ii. buy order and each sale having a sale price paid to its corresponding sell order;
iii. sending a portion of each purchase price to each of a plurality of investors in the exchange.

41. The method of claim 23, wherein the daily cash index is also based on real estate transactions.

42. A method for matching buy and sell orders, comprising the steps of:
maintaining a daily cash index of real estate values for a local region based on real estate transactional activity;
creating a trading instrument representative of an interest in real estate in the local region, wherein a cash settlement of the trading instrument is a function of the daily cash index on the date of said cash settlement;
generating a plurality of buy orders relating to the instrument;
generating a plurality of sell orders relating to the instrument; and
matching the buy and sell orders to determine a purchase and sale of the instrument

43. A method for matching buy and sell orders, comprising the steps of:
maintaining a daily cash index of real estate values for a local region based on real estate statistics;
creating a trading instrument representative of an interest in real estate in the local region, wherein a cash settlement of the trading instrument is a function of the daily cash index on the date of said cash settlement;
generating a plurality of buy orders relating to the instrument;
generating a plurality of sell orders relating to the instrument; and
matching the buy and sell orders to determine a purchase and sale of the instrument
